(19) United States
(12) Patent Application Publication
(10) Pub. No.: US 2018/0293422 A1
(43) Pub. Date: Oct. 11, 2018

(54) Optical Fingerprint Module

(71) Applicant: SHANGHAI OXI TECHNOLOGY CO., LTD, Shanghai (CN)

(72) Inventors: Yan Ling, Shanghai (CN); Hong Zhu, Shanghai (CN)

(73) Assignee: SHANGHAI OXI TECHNOLOGY CO., LTD, Shanghai (CN)

(21) Appl. No.: 15/765,973

(22) PCT Filed: Aug. 18, 2016
(86) PCT No.: PCT/CN2016/095824

§ 371 Date: Apr. 4, 2018

(30) Foreign Application Priority Data
Jul. 8, 2016 (CN) 201610536759.0

(51) Int. Cl. G06K 9/00; H05B 33/08

(52) U.S. Cl. CPC G06K 9/0004; F21Y 2115/10; G06K 9/00046; H05B 33/0857

(57) ABSTRACT

An optical fingerprint module, including: an optical fingerprint sensor; a point backlight source; the optical fingerprint sensor includes and only includes a non-opaque substrate; the first surface of the non-opaque substrate being directly used for fingerprinting contact; the second surface of the non-opaque substrate includes a device layer; the device layer includes a pixel area; the pixel area includes a plurality of pixels; each of the pixels includes a non-opaque area and a light-blocking area; and the light-blocking area includes a photosensitive device formed therein; the non-opaque area allows light to pass through the pixel area of the device layer; the point backlight source is disposed below the pixel area, and an angle between the light emitted from the point backlight source and the first surface of the non-opaque substrate is acute. The structure of the optical fingerprint module is simplified and the performance is improved.

### CROSS-REFERENCE TO RELATED APPLICATIONS

This application claims the benefit of priority to Chinese Patent Application No. 201610536759.0, filed on Jul. 8, 2016, and entitled “Optical Fingerprint Sensor Module”, the entire disclosure of which is incorporated herein by reference.

### TECHNICAL FIELD

The present invention relates to the field of optical fingerprint recognition, and more particularly, to an optical fingerprint module.

### BACKGROUND

Fingerprint recognition technology is used to realize identification by capturing fingerprint images of a person using optical fingerprint sensors (or modules), and then determine whether the fingerprint image information matches that stored in the system before. Due to its easy to use, and the uniqueness of the fingerprint recognition technology has been widely applied in various fields, such as security inspection field including public security bureau, customs and the like, building entrance guard field, as well as consumption goods field including personal computers, mobile phones and the like. The fingerprint recognition technology includes optical imaging, capacitance imaging, ultrasound imaging and the like, among which optical fingerprint recognition technology is advantageous in the image quality and device cost.

The Chinese utility model patent with public number CN203405831U can be referred to for more information on the optical fingerprint sensor.

Therefore, there is a need for an improvement for the structure and the performance of the present optical fingerprint module.

### SUMMARY

Embodiments of the present disclosure provide an optical fingerprint module with optimized structure to improve the performance and function of the optical fingerprint module.

The present disclosure provides an optical fingerprint module, including: an optical fingerprint module, an optical fingerprint sensor; and a point backlight source; wherein the optical fingerprint sensor includes one non-opaque substrate; a first surface of the non-opaque substrate is used for fingerprinting contact; a second surface of the non-opaque substrate is covered with a device layer; the device layer includes a pixel area; the pixel area includes a plurality of pixels; each of the plurality of pixels includes a non-opaque area and a light-blocking area, the light-blocking area includes a photosensitive device; the non-opaque area allows light to pass through the pixel area of the device layer; the point backlight source is disposed below the pixel area, and an angle between the light emitted from the point backlight source and the first surface of the non-opaque substrate is an acute angle.

In some embodiments, the point backlight source is disposed below the device layer, and the light emitted from the point backlight source penetrates through the non-opaque area to the device layer, and then enters into the non-opaque substrate.

In some embodiments, each of the plurality of pixels further includes a light shielding layer, the photosensitive device is disposed between the light shielding layer and the non-opaque substrate, the light shielding layer is disposed between the photosensitive device and the point backlight source.

In some embodiments, the point backlight source may include at least one LED, and the light of the LED includes near ultraviolet light, violet light, blue light, green Light, yellow light, red light, near infrared light or white light; or the backlight source may include two or more LEDs symmetrically disposed below the optical fingerprint sensor, and the light of the LED may include near ultraviolet light, purple light, blue light, green light, yellow light, red light, near infrared light or white light.

In some embodiments, a focusing lens is disposed in front of a light emitting surface of the point backlight source; the focusing lens is adapted to focus the light emitted from the point backlight source to parallel light or near parallel light, and the light emitted from the point backlight source first enters the focusing lens, and then enters the optical fingerprint sensor.

In some embodiments, a first anti-reflective layer is disposed on the surface of the device layer; the first anti-reflective layer is adapted to increase the proportion of the light emitted from the point backlight source entering into the optical fingerprint sensor.

In some embodiments, a non-opaque layer is disposed between the optical fingerprint sensor and the backlight source, and the light emitted from the point backlight source first enters the non-opaque layer, and then into the optical fingerprint sensor.

In some embodiments, a side surface or a lower surface of the non-opaque layer act as a light-focusing surface, and the light emitted from the point backlight source enters from the light-focusing surface to the non-opaque layer, where the light-focusing surface focuses light emitted from the point backlight source into parallel light or near-parallel light.

In some embodiments, a second anti-reflective layer is disposed on a side surface or a lower surface of the non-opaque layer, and the second anti-reflective layer is adapted to increase the proportion of the light emitted from the point backlight source entering into the non-opaque layer.

In some embodiments, the non-opaque layer includes a glass layer, a plastic layer, or an optical adhesive layer; and the light-focusing surface of the non-opaque layer includes a slant surface, a spherical crown surface, an ellipsoidal crown surface, a conical side surface or a pyramid side surface.

In some embodiments, a refractive index of the non-opaque layer is greater than 1.2.

In some embodiments, a filter layer is disposed on at least one of the first surface and the second surface of the non-opaque substrate.

Compared with the prior art, embodiments of the present disclosure has the following advantages:

A new optical fingerprint module is provided, wherein the optical fingerprint module includes only one non-opaque substrate. The light emitted from the point backlight source only needs to pass through the devices layer and one non-opaque substrate. The light passes less substrate, which is helpful to form a clear fingerprint image. The structure of the optical fingerprint is simplified with the simple structure and reduced thickness, which lowers the cost. The light emitted from the point backlight source reaches the first surface of the non-opaque substrate to form an acute angle with the first surface. With this, reflection occurs for all the light at the interface between the first surface and the contact interface of finger with a corresponding shift distance, and most of the effective reflected light is irradiated into corresponding pixels in the pixel area at a substantially same shift distances from the corresponding reflection points. Therefore, the entire optical fingerprint module can achieve fingerprint image recognition without a light guide plate to form a clear fingerprint image, which further simplifies the structure of the optical fingerprint and lowers the cost.

Further, the backlight source may include two LEDs. In the process of fingerprint image acquisition, either of the LED can be chosen as an imaging light source, or the two LEDs can be alternately chosen as illuminating lights to form fingerprint images, and then a corresponding image calculation can be conducted, so as to obtain a fingerprint image with smaller distortion and higher accuracy, which further improves the performance of optical fingerprint module.

Further, there is disposed a first anti-reflective layer on the surface of the optical fingerprint sensor close to the point backlight source. The anti-reflective layer is adapted to increase the proportion of the light from the backlight source entering the non-opaque substrate. Therefore, more light can be used for the fingerprint image capture, whereby the fingerprint image with higher definition and accuracy can be obtained, and optical fingerprint module with further improved performance can be obtained.

Further, there is disposed a focusing lens in front of the light emitting surface of the point backlight source; where the focusing lens is adapted to focus the light from the LED to parallel light or near parallel light, and the light of the backlight source first enters the focusing lens and then enters the optical fingerprint sensor. Therefore, more light can be used for the fingerprint image capture, so as to obtain a fingerprint image with smaller distortion and higher accuracy, which further improves the performance of optical fingerprint module.

Further, a non-opaque layer is disposed between the optical fingerprint sensor and the backlight source. The light emitted from the point backlight source can reach the non-opaque substrate at a greater incident angle by increasing the refractive index of non-opaque layer to a refractive index greater than that of the air, and making the light entering the non-opaque layer from a side surface of the non-opaque layer (i.e., the light will reach the first surface of the non-opaque substrate at an angle parallel to the first surface). Total reflection takes place when the incident angle of light is greater than a certain value (i.e., when the incident angle is greater than a critical angle, total reflection takes place at the interface between the non-opaque substrate and air), which improves the definition of the image and further ensures a more clear and accurate fingerprint image, and thus obtains a improved optical fingerprint image sensor module.

Further, a side surface or a lower surface of the non-opaque layer can be made into a light-focusing surface, and the light-focusing surface can focus the light emitted from the backlight source into parallel light or near-parallel light. The light emitted from the point backlight source first enters the non-opaque layer from the focusing surface, and then enters the optical fingerprint sensor, therefore, parallel light or near-parallel light can be used for fingerprint image acquisition, to obtain fingerprint images with smaller distortion and higher accuracy, which further improves the performance of optical fingerprint image sensor module.

Further, a second anti-reflective layer is disposed on the side surface or lower surface of the non-opaque layer. The second anti-reflective layer can increase the proportion of the light emitted from the backlight source entering into the non-opaque substrate. Therefore, more light can be used for the fingerprint image capture, whereby the fingerprint image with higher definition and accuracy can be obtained, and optical fingerprint module with further improvement in the performance can be obtained.

### BRIEF DESCRIPTION OF THE DRAWINGS

FIG. 1 is a schematic top view of an optical fingerprint sensor and a point backlight source in an optical fingerprint module according to an embodiment of the present invention;

FIG. 2 is a schematic cross-sectional view of an optical fingerprint module according to an embodiment of the present invention;

FIG. 3 is a schematic cross-sectional view of an optical fingerprint module according to an embodiment of the present invention;

FIG. 4 is a schematic cross-sectional view of an optical fingerprint module according to an embodiment of the present invention;

FIG. 5 is a schematic cross-sectional view of an optical fingerprint module according to an embodiment of the present invention;

FIG. 6 is a schematic cross-sectional view of an optical fingerprint module according to an embodiment of the present invention;

FIG. 7 is a schematic cross-sectional view of an optical fingerprint module according to an embodiment of the present invention; and

FIG. 8 is a schematic cross-sectional view of an optical fingerprint module according to an embodiment of the present invention.

### DETAILED DESCRIPTION

An optical fingerprint sensor according to existing technology includes at least a non-opaque substrate and a protective layer. It is almost inevitable to increase the thickness of the entire optical fingerprint sensor. And the increased thickness also causes the light emitted from the light source to go through a long optical path to reach the photosensitive device, which limits the further improvement of the quality of the captured fingerprint image.

Therefore, embodiments of the present disclosure provide an optical fingerprint module. Through simplifying the structure of optical fingerprint sensor by omitting the protective layer, the thickness of the optical fingerprint module can be reduced and the captured fingerprint image quality can be improved.

The foregoing objects, features and advantages of the present invention will become more apparent from the following detailed description of specific embodiments of the invention taken in conjunction with the accompanying drawings.

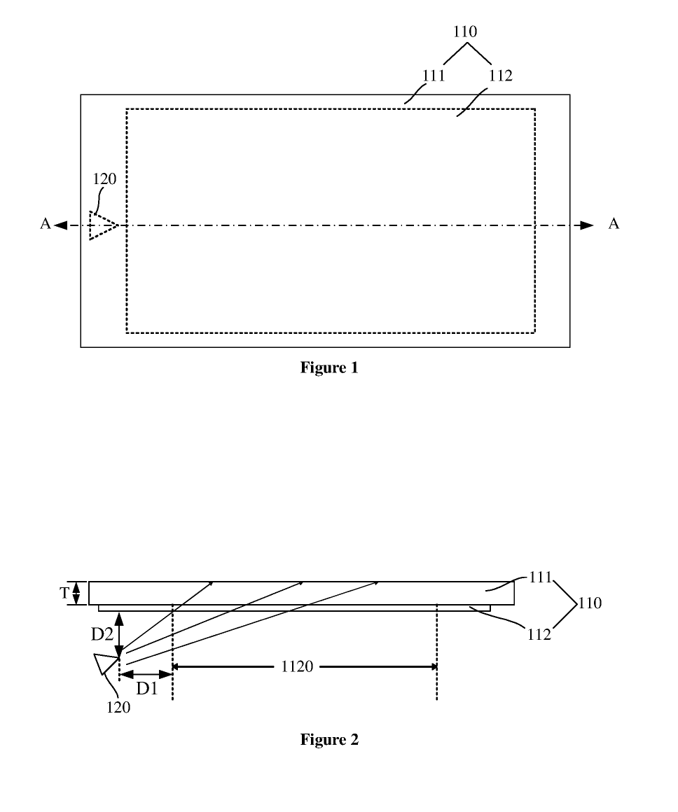

An embodiment of the present invention provides an optical fingerprint module as shown in FIG. 1 and FIG. 2.

FIG. 1 is a schematic top view of an optical fingerprint sensor and a point backlight source in an optical fingerprint module according to an embodiment of the present invention (the dotted line in FIG. 1 represents the structure disposed in a lower layer, which may be referred to FIG. 2). FIG. 2 is a schematic cross-sectional view of an optical fingerprint module according to an embodiment of the present invention. FIG. 2 is a cross sectional view of the optical fingerprint module shown in FIG. 1 along lines A-A.

Referring to FIG. 1 and FIG. 2, the optical fingerprint module includes an optical fingerprint sensor 110 and a point backlight source 111.

The optical fingerprint sensor 110 includes one and only one non-opaque substrate. A first surface (not labeled) of the non-opaque substrate is used for fingerprinting contact. A second surface (not labeled) of the non-opaque substrate is covered with a device layer 112. As shown in FIG. 2, the first surface includes an upper surface of the non-opaque substrate 111, and the second surface includes a lower surface of the non-opaque substrate 111.

In some embodiment, the thickness of the non-opaque substrate is less than 5 cm. The non-opaque substrate 111 may be made of glass or plastic.

As shown in FIG. 2, the device layer 112 includes a pixel area 1120. The pixel area 1120 is marked among two long dashed lines, which means that in the plane of the cross section shown in FIG. 2, the pixel area 1120 is disposed among the area of the two long dashed lines in the device layer 112. The area disposed right below the pixel area 1120 refers to the area disposed among the area of the two long dashed lines but below the pixel area 1120. The labeling of the corresponding pixel regions with above-described method is also applied in other embodiment which is explained herein.

Although not shown in the figure, the pixel area 1120 takes rectangular shape; the length of each side of the pixel area 1120 may be selected according to the product requirements.

Although not shown in the figure, in the pixel area 1120, a plurality of pixels (not shown) may be arranged in a pixel array, and a plurality of scanning lines (not shown) and a plurality of data lines (not shown) can be disposed in the rows and columns of the pixel array. In an embodiment, a plurality of scanning lines may be disposed along a first axial direction, and a plurality of data lines may be disposed along a second axial direction; a plurality of grids are defined by the plurality of the scanning lines and the plurality of data lines, and the plurality of pixels are disposed in the grid. Where, each of the plurality of pixels may be a rectangular and each side of the rectangle is less than or equal to 100 μm.

Each of the plurality of pixels includes a non-opaque area (not shown) and a light-blocking area (not shown), the light-blocking area includes a photosensitive device (not shown), and the non-opaque area allows light to pass through the device layer 112 and the pixel area 1120.

It should be noted that, in the device layer 112, a non-opaque structure may be disposed in other areas around the pixel area 1120. That is, the non-opaque structure may be disposed in other areas on the condition not affecting the corresponding structure and functions (e.g., a drive circuit and a bonding pin in the area around the pixel area 1120 to realize functions such as driving and binding) in the other areas.

As shown in FIG. 2, the point backlight source 120 is disposed below the pixel area 1120, where an angle between the light emitted from the point backlight source 120 and the first surface of the non-opaque substrate 111 is an acute angle. More specifically, the angle between the light emitted from the point backlight source 120 and a portion of the first surface right facing to the pixel area 1120 is an acute angle.

As shown in FIG. 2, the point backlight source 120 is disposed below the device layer 112, the light emitted from the point backlight source 120 passes through the device layer 112 from the non-opaque area, and enters the non-opaque substrate 111.

As shown in FIG. 2, the point backlight source 120 includes a LED. The light of the LED may include near ultraviolet light, violet light, blue light, green light, yellow light, red light, near infrared light or white light.

In the present embodiment, the light emitted from the backlight source 120 is shown as a black unidirectional arrow in FIG. 2. As described above, the area right below the pixel area 1120 is marked among two long dashed lines, and the point backlight source 120 is disposed outside of the area. In the cross sectional view of FIG. 2, there is a first distance D1 between the point backlight source 120 and the area right below the pixel area 1120 in the horizontal direction; and in the vertical direction, there is a second distance D2 between the point backlight source 120 and the device layer 112.

As described above, the point backlight source 120 is disposed below the pixel area 1120 due to the first distance D1 and the second distance D2, and it is easy to understand that the “below” means being disposed outside of and under the pixel area 1120, or obliquely below the pixel area 1120.

In the present embodiment, the point backlight source 120 may be disposed at an appropriate position by adjusting the first distance D1 and the second distance D2 (but always greater than or equal to 0) to improve the clarity of the fingerprint image formed by the optical fingerprint module.

It should be noted that, in some embodiment of the present disclosure, the point backlight source may include two or more LEDs, the two or more LEDs may be symmetrically and evenly disposed below the optical fingerprint sensor, and the light of each LED may include near ultraviolet light, purple light, blue light, green light, yellow light, red light, near infrared light or white light. If the point backlight source includes two or more LEDs, the light of each LED may be the same or different; or the lights from some LEDs are the same, while the lights from other LEDs are different.

Although not shown in the figure, a light shielding layer is also included in the plurality of pixels. A photosensitive device is disposed between the light shielding layer and the non-opaque substrate 111, and the light shielding layer is disposed between the photosensitive device and the point backlight source 120. Due to the position of the light shielding layer, the photosensitive device may only receive an optical signal emitted from the non-opaque substrate 111 and then entering the device layer 110, while the light emitted from the point backlight source 120 can not directly illuminate to the photosensitive device from the bottom of the device layer 110.

In other embodiments, at least one of the first surface and the second surface of the non-opaque substrate is covered with a filter layer. The filter layer may include at least one of an interference reflection layer and a light absorption layer. Further, the interference reflection layer may be adapted to enlarge the difference of the reflected light from the position in contact with finger and not in contact with finger, thereby increasing the image contrast and reducing the interference of the ambient light to the fingerprint image, so as to reduce the influence of the ambient light on the fingerprint imaging.

In the optical fingerprint module provided by present embodiment, the optical fingerprint sensor 110 includes only one non-opaque substrate 111. The light emitted from the point backlight source 120 only needs to pass through the device layer 112 and one non-opaque substrate 111. The light passes less substrate, which is helpful to form a clear fingerprint image. The structure of the optical fingerprint module is simplified with the simple structure and reduced thickness, which lowers the cost. The light emitted from the point backlight source 120 reaches the first surface of the non-opaque substrate 111 to form an acute angle with the first surface, reflection occurs for all the light at the interface between the first surface and the contact interface of fingerprint with a corresponding shift distance, and most of the effective reflected light is irradiated into corresponding pixels in the pixel area 1120 at a substantially same shift distances from the corresponding reflection points. Therefore, the entire optical fingerprint module can achieve fingerprint image without a light guide plate to form a clear fingerprint image, which further simplifies the structure of the optical fingerprint module and lowers the cost.

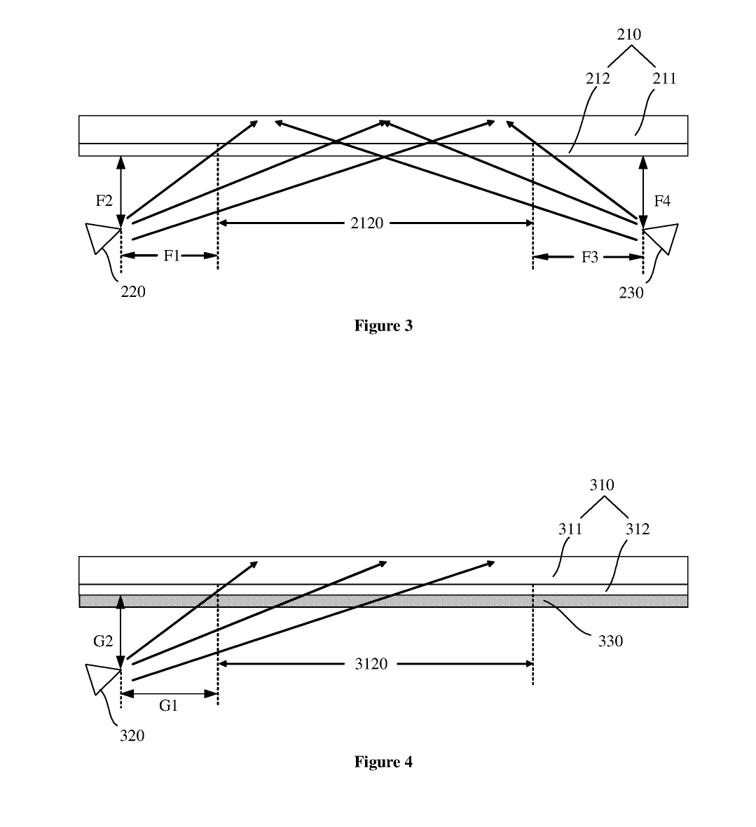

Another embodiment of the present disclosure provides an optical fingerprint module. FIG. 3 is a schematic cross-sectional view of the optical fingerprint module according to an embodiment of the present invention. The optical fingerprint module includes an optical fingerprint sensor 210 and a point backlight source (not labeled).

As shown in FIG. 3, the optical fingerprint sensor 210 includes one and only one non-opaque substrate 211. A first surface (not labeled) of the non-opaque substrate is used for finger contact, a second surface (not labeled) of the non-opaque substrate is covered with a device layer 212. As shown in FIG. 3, the first surface includes an upper surface of the non-opaque substrate 211, and the second surface includes a lower surface of the non-opaque substrate 211.

In present embodiment, the device layer 212 includes a pixel area 2120, the pixel area 2120 includes a plurality of pixels (not shown), each of the plurality of pixels includes a non-opaque area (not shown) and a light-blocking area (not shown), the light-blocked area includes a photosensitive device (not shown), and the non-opaque area allows the light to pass through the device layer 212 and the pixel area 2120.

Referring to FIG. 3, the present embodiment differs from the foregoing embodiment in that the point backlight source includes two LEDs, a LED 220 and a LED 230, respectively. The LED 220 and the LED 230 are disposed below the pixel area 2120, and the angle between the light emitted from the LED 220 or the LED 230 and the first surface of the non-opaque substrate 211 is an acute angle. That is, in the present embodiment, the point backlight source is also disposed outside of and under the pixel region 2120; therefore the angle between the light emitted from the point backlight source and the upper surface of the first surface is an acute angle.

As shown in FIG. 3, the light emitted from the LED 220 and the LED 230 is shown as a black unidirectional arrow in FIG. 3. The LED 220 and the LED 230 are disposed outside of and under the pixel area 2120, that is, the LED 220 and the LED 230 are disposed at a lower portion of the two sides of the outside of the pixel area 2120. As shown in FIG. 3, the area right below the pixel area 2120 is between two long dashed lines, and the LED 220 and the LED 230 fall outside of this area.

As shown in the cross section of FIG. 3, there is a first distance F1 between the LED 220 and the area right below the pixel area 2120 in the horizontal direction; and in the vertical direction, there is a second distance F2 between the LED 220 and the device layer 212. As described above, the LED 220 is disposed outside of and under the pixel area 2120 due to the first distance F1 and the second distance F2. In the present embodiment, the LED 220 may be disposed at an appropriate position by adjusting the first distance F1 and the second distance F2 to improve the clarity of the fingerprint image formed by the optical fingerprint module.

Similarly, there is a third distance F3 between the LED 230 and the area right below the pixel area 2120 in the horizontal direction; and in the vertical direction, there is a fourth distance F4 between the LED 212 and the device layer 212. As described above, the LED 230 is disposed outside of and under the pixel area 2120 due to the third distance F3 and fourth distance F4. In the present embodiment, the LED 230 may be disposed at an appropriate position by adjusting the third distance F3 and the fourth distance F4 to improve the clarity of the fingerprint image formed by the optical fingerprint module.

It should be noted that, when the point backlight source includes two or more LEDs (for example, the LED 220 and the LED 230 in the present embodiment), the distance between the point backlight source and the pixel area 2120 may be the shortest distance of all the distances between the pixel area 2120 and the LEDs.

In present embodiment, the light of LED 220 and LED 230 may include near ultraviolet light, purple light, blue light, green light, yellow light, red light, near infrared light or white light. And, the light of the two LEDs may be the same, or different. It should be noted that, in other embodiments, the point backlight source may include three or more LEDs, and the three or more LEDs may be symmetrically and evenly disposed below the optical fingerprint sensor 210. For example, if the point backlight source includes four LEDs and the top view of the pixel region 2120 takes rectangular shape, the four LEDs may be symmetrically disposed below the four sides of the rectangular pixel region 2120. In other embodiments, the light of each LED may include near ultraviolet light, purple light, blue light, green light, yellow light, red light, near infrared light or white light. The light of each LED may be the same or different; or the lights from some LEDs are same, while the lights from other LEDs are different.

The entire optical fingerprint module provided in present embodiment can achieve fingerprint image recognition without a light guide plate to form a clear fingerprint image, which further simplifies the structure of the optical fingerprint module and lowers the cost. The point backlight source includes the LED 220 and the LED 230, thus any one of the LEDs can be chosen as the imaging light source of the fingerprint image when performs the fingerprint image capture, and the present embodiment can achieve similar effect to the former embodiments.

There is a certain range of divergence angle between the outgoing light of the LED 220 and the LED 230, namely, not in parallel, thus the incident angles of the light reaching different areas of the first surface is slightly different. The shift distance of the pixels illuminated by the reflected light from different areas of the first surface to the corresponding reflection point is slightly different, which may produce slight image distortion. The thicker the non-opaque substrate, the greater the absolute amount of distortion. In the present embodiment, the light emitted from the two LEDs can be alternately utilized for imaging and then the corresponding image calculation may be performed to obtain a fingerprint image with smaller amount of distortion and higher accuracy, which may further improve the optical fingerprint module performance. In other embodiments, if the point backlight source includes more LEDs, each LED can be used alternately for imaging, and then perform noise reduction calculation and compensation calculation to obtain fingerprint image with a higher resolution and a higher accuracy, which may further improves the performance of optical fingerprint module.

More information on the structure and properties of the optical fingerprint module of the present embodiment, please refer to the corresponding description of the optical fingerprint module provided in the foregoing embodiments.

Another embodiment of present disclosure provides an optical fingerprint module, please refer to FIG. 4. FIG. 4 is a schematic cross-sectional view of an optical fingerprint module according to an embodiment of the present disclosure; the optical fingerprint module includes an optical fingerprint sensor 310 and a point backlight source 320.

As shown in FIG. 4, the optical fingerprint sensor 310 includes one non-opaque substrate 311. A first surface (not labeled) of the non-opaque substrate 311 is used for fingerprinting contact. A second surface (not labeled) of the non-opaque substrate 311 is covered with a device layer 312. As shown in FIG. 3, the first surface includes the upper surface of the non-opaque substrate 311, and the second surface includes the lower surface of the non-opaque substrate 311.

In present embodiment, the device layer 312 includes a pixel area 3120. The pixel area 3120 includes a plurality of pixels (not shown), each of the plurality of pixels includes a non-opaque area (not shown) and a light-blocking area (not shown), the light-blocking area includes a photosensitive device (not shown), and the non-opaque area allows light to pass through the device layer 312 and the pixel area 3120.

Referring to FIG. 4, the point backlight source 320 is disposed below the pixel area 3120, and the angle between the light emitted from the point backlight source 320 and the first surface of the non-opaque substrate 311 is an acute angle. That is, the point backlight source 320 is disposed outside of and under the pixel region 3120, therefore the angle between the light emitted from the point backlight source 320 and the upper surface of the first surface is an acute angle.

In present embodiment, the point backlight source 320 includes a LED. The light emitted from the point backlight source 320 is shown as a black unidirectional arrow in FIG. 4. As shown in the cross section of FIG. 4, there is a first distance G1 between the point backlight source 320 and the area right below the pixel area 3120 in the horizontal direction; and in the vertical direction, there is a second distance G2 between the point backlight source 320 and the device layer 312. As described above, the LED 320 is disposed below the pixel area 3120 due to the first distance G1 and the second distance G2, and it is easy to understand that “below” means being disposed outside of and under the pixel area 3120. In the present embodiment, the point backlight source 320 may be disposed at an appropriate position by adjusting the first distance G1 and the second distance G2 to improve the clarity of the fingerprint image formed by the optical fingerprint module.

The present embodiment differs from the foregoing embodiment in that a surface of the optical fingerprint sensor 310 closing to the point backlight source 320 includes a first anti-reflective layer 330, and the first anti-reflective layer 330 is adapted to increase the proportion of the light emitted from the backlight source 320 entering into the optical fingerprint sensor 310.

In the present embodiment, the first anti-reflective layer 330 is directly deposited on the surface of the device layer 312, thereby reducing the thickness of the optical fingerprint module.

The entire optical fingerprint module provided in present embodiment can achieve fingerprint image recognition without a light guide plate to form a clear fingerprint image, which further simplifies the structure of the optical fingerprint module and lowers the cost. Further, a surface of optical fingerprint sensor 310 closing to the point backlight source 320 includes a first anti-reflective layer 330, and the first anti-reflective layer is adapted to increase the proportion of the light emitted from the backlight source 320 entering into the optical fingerprint sensor 310. Therefore, when the fingerprint image acquisition is carried out, more light can be used for the fingerprint image capture, thereby achieving fingerprint image with higher definition and accuracy, and obtaining optical fingerprint module with further improvement.

Further, regarding the structure and properties of the optical fingerprint module provided in the present embodiment, reference can be made to the corresponding contents of the optical fingerprint module provided in the foregoing embodiments.

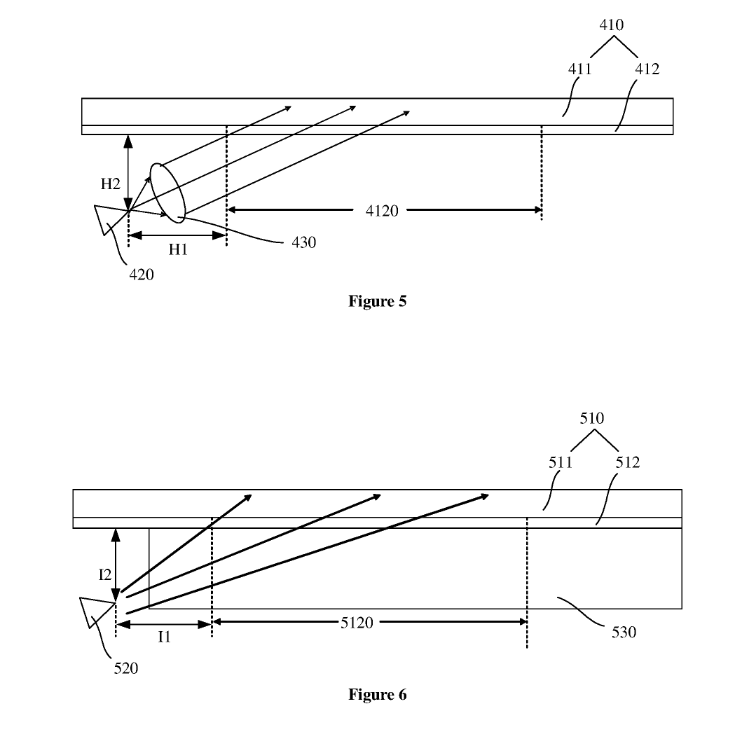

Another embodiment of present disclosure provides an optical fingerprint module, please refer to FIG. 5. FIG. 5 is a schematic cross-sectional view of an optical fingerprint module according to an embodiment of the present disclosure. The optical fingerprint module includes an optical fingerprint sensor 410 and a point backlight source 420.

As shown in FIG. 5, the optical fingerprint sensor includes one non-opaque substrate 411. A first surface (not labeled) of the non-opaque substrate 411 is used for fingerprinting contact. A second surface (not labeled) of the non-opaque substrate is covered with a device layer 412. As shown in FIG. 5, the first surface includes the upper surface of the non-opaque substrate 411, and the second surface includes the lower surface of the non-opaque substrate 411.

In present embodiment, the pixel area 4120 includes a plurality of pixels (not shown), each of the plurality of pixels includes a non-opaque area (not shown) and a light-blocking area (not shown), the light-blocking area includes a photosensitive device (not shown), and the non-opaque area allows the light to pass through the device layer 412 and the pixel area 4120.

Referring to FIG. 5, the point backlight source 420 is disposed below the pixel area 4120, and the angle between the light emitted from the point backlight source 420 and the first surface of the non-opaque substrate 411 is an acute angle. That is, the point backlight source 420 is disposed outside of and under the pixel region 4120; therefore the angle between the light emitted from the point backlight source 420 and the upper surface of the first surface is an acute angle.

In present embodiment, the point backlight source 420 includes a LED. The light emitted from the point backlight source 420 is shown as a black unidirectional arrow in FIG. 5. As shown in the cross section of FIG. 5, there is a first distance H1 between the point backlight source 420 and the area right below the pixel area 4120 in the horizontal direction; and in the vertical direction, there is a second distance H2 between the point backlight source 420 and the device layer 412. As described above, the point backlight source 420 is disposed below the pixel area 4120 due to the first distance H1 and the second distance H2, and it is easy to understand that “below” means being disposed outside of and under the pixel area 4120. In the present embodiment, the point backlight source 420 may be disposed at an appropriate position by adjusting the first distance H1 and the second distance H2 to improve the clarity of the fingerprint image formed by the optical fingerprint module.

In the present embodiment, a focusing lens 430 is disposed in front of the point backlight source 420. The focusing lens 430 may be adapted to focus the light emitted from the point backlight source 420 to parallel light or near-parallel light. The light emitted from the point backlight source 420 first enters the focusing lens 430, and then enters the optical fingerprint sensor 410.

It should be noted that the near-parallel light refers to a maximum angle difference between all the light within 10 degrees.

In the present embodiment, when the focusing lens 430 is a convex lens, the light passing through the focusing lens 430 is adjusted to the parallel light when the distance between the point backlight source 420 and the focusing lens 430 is equal to the focal length of the convex lens. In other embodiments, the focusing lens 430 may be other suitable lenses, such as a Fresnel lens.

The entire optical fingerprint module provided in present embodiment can achieve fingerprint image recognition without a light guide to form a clear fingerprint image, which further simplifies the structure of the optical fingerprint module and lowers the cost. And a focusing lens 430 is disposed in front of the point backlight source 420. The focusing lens 430 may be adapted to focus the light emitted from the point backlight source 420 to parallel light or near-parallel light. The light emitted from the point backlight source 420 first enters the focusing lens 430, and then enters the optical fingerprint sensor 410. Therefore, the parallel light or near-parallel light may be used for fingerprint image acquisition, thereby achieving fingerprint image with smaller distortion and higher accuracy, which further improves the performance of optical fingerprint module.

Further, regarding the structure and properties of the optical fingerprint module provided in the present embodiment, reference can be made to the corresponding contents of the optical fingerprint module provided in the foregoing embodiments.

Another embodiment of present disclosure provides an optical fingerprint module, please refer to FIG. 6. FIG. 6 is a schematic cross-sectional view of an optical fingerprint module according to an embodiment of the present invention, the optical fingerprint module includes an optical fingerprint sensor 510 and a point backlight source 520.

As shown in FIG. 6, the optical fingerprint sensor includes one non-opaque substrate 511. A first surface (not labeled) of the non-opaque substrate 511 is used for fingerprinting contact. A second surface (not labeled) of the non-opaque substrate is covered with a device layer 512. As shown in FIG. 5, the first surface includes the upper surface of the non-opaque substrate 511, and the second surface includes the lower surface of the non-opaque substrate 511.

In present embodiment, the device layer 512 includes a pixel area 5120. The pixel area 5120 includes a plurality of pixels (not shown), each of the plurality of pixels includes a non-opaque area (not shown) and a light-blocking area (not shown), the light-blocking area includes a photosensitive device (not shown), and the non-opaque area allows the light to pass through the device layer 512 and the pixel area 5120.

Referring to FIG. 6, the point backlight source 520 is disposed below the pixel area 5120, and the angle between the light emitted from the point backlight source 520 and the first surface of the non-opaque substrate 511 is an acute angle. That is, the point backlight source 520 is disposed outside of and under the pixel area 5120.

In the present embodiment, the point backlight source 520 includes a LED. The point backlight source 520 is disposed below the pixel area 5120, and the angle between the light emitted from the point backlight source 520 and the upper surface of the first surface is an acute angle.

In the present embodiment, the light emitted from the point backlight source 520 is shown as a black unidirectional arrow in FIG. 6. As shown in the cross section of FIG. 6, there is a first distance I1 between the point backlight source 520 and the area right below the pixel area 5120 in the horizontal direction; and in the vertical direction, there is a second distance 12 between the point backlight source 520 and the device layer 412. As described above, the point backlight source 520 is disposed below the pixel area 5120 due to the first distance I1 and the second distance 12, and it is easy to understand that the “below” means being disposed outside of and under the pixel area 5120. In the present embodiment, the point backlight source 520 may be disposed at an appropriate position by adjusting the first distance I1 and the second distance 12 to improve the clarity of the fingerprint image formed by the optical fingerprint module.

As shown in FIG. 6, a non-opaque layer 530 is disposed between the optical fingerprint sensor 510 and the point backlight source 520. The light emitted from point backlight source 520 may first enter the non-opaque layer 530, and then enter the optical fingerprint sensor 510.

It should be noted that, although in the present embodiment the entire optical fingerprint module includes the non-opaque layer 530, the optical fingerprint sensor 510 includes only one non-opaque substrate 511. It should be noted that, the optical fingerprint sensor 510 is a simplified structure, thus the non-opaque layer 530 disposed between the optical fingerprint sensor 510 and the point backlight source 520 does not constitute a part of the optical fingerprint sensor 510.

In the present embodiment, the refractive index of the non-opaque layer 530 is greater than that of the air, and in the present embodiment, the light emitted from the point backlight source 520 may enter into the non-opaque layer 530 from a side surface of the non-opaque layer 530. The side surface is generally vertical or nearly vertical. Thus, the present embodiment allows the light to enter the first surface with a greater incident angle (i.e., the light will reach the first surface of the non-opaque substrate at an angle parallel to the first surface) through increasing the refractive index of non-opaque layer 530 to a refractive index greater than that of the air and making the light enter the non-opaque layer 530 from the side surface of the non-opaque layer 530. And total reflection takes place when the incident angle of light is greater than a certain value (i.e., when the incident angle is greater than the critical angle, total reflection will take place at the interface of non-opaque substrate and air interface), therefore the clarity of the image would be improved obviously.

Further, in the present embodiments, a refractive index of the non-opaque layer 530 is greater than 1.2, which further improves the performance of optical fingerprint module.

In the present embodiment, the non-opaque layer 530 may include a glass layer, a plastic layer, or an optical adhesive layer.

It should be noted that, although not shown in the figure, an optical adhesive layer may be disposed between the optical fingerprint sensor 510 of the present embodiment and the non-opaque layer 530. The light emitted from the point backlight source 520 first enters into the optical adhesive layer from the non-opaque layer 530, and then enters into the optical fingerprint sensor 510. The optical adhesive layer may be adapted to prevent the air between the optical fingerprint sensor 510 and the non-opaque layer 530, thereby preventing the scattering and refraction of light in the air between the optical fingerprint sensor 510 and non-opaque layer 530, which improves the quality of the subsequent fingerprint image.

It should be noted that, in other embodiments, the light emitting surface of the point backlight source 520 may be directly covered by the corresponding non-opaque layer 530, thus the light emitted from the point backlight source 520 can be emitted from the point backlight source 520 and then enter into the non-opaque layer 530 directly, therefore the light does not need to pass through the air when it is transmitting in the module, thereby further improving the quality of the subsequent fingerprint image.

Further, regarding the structure and properties of the optical fingerprint module provided in the present embodiment, reference can be made to the corresponding contents of the optical fingerprint module provided in the foregoing embodiments.

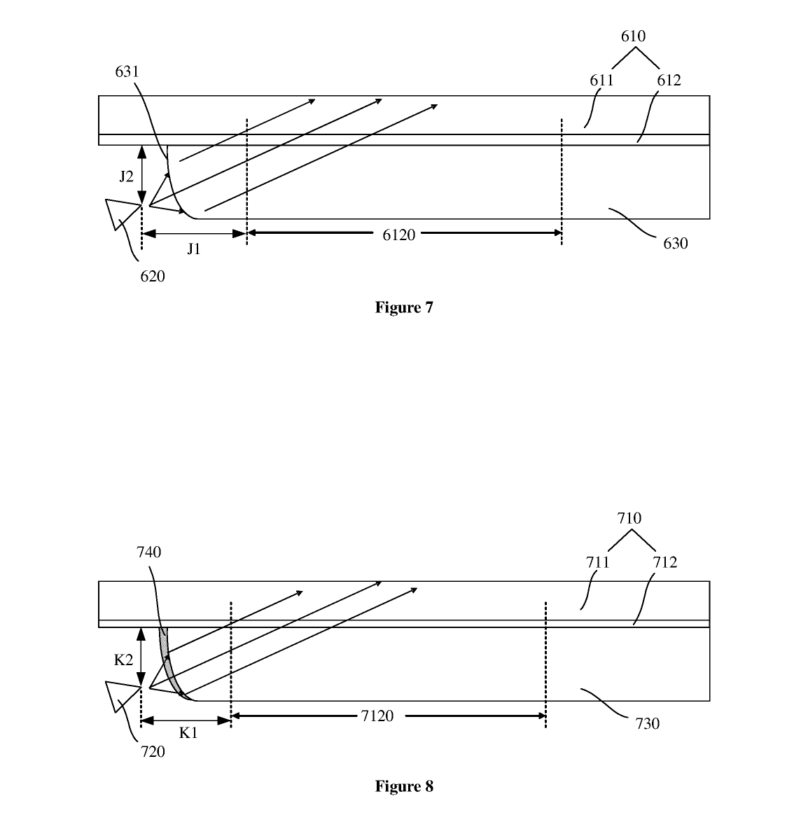

Another embodiment of present disclosure provides an optical fingerprint module, please refer to FIG. 7. FIG. 7 is a schematic cross-sectional view of an optical fingerprint module according to an embodiment of the present invention, the optical fingerprint module includes an optical fingerprint sensor 610 and a point backlight source 620.

As shown in FIG. 7, the optical fingerprint sensor included one non-opaque substrate 611. A first surface (not labeled) of the non-opaque substrate 611 is used for fingerprinting contact. A second surface (not labeled) of the non-opaque substrate is covered with a device layer 612. As shown in FIG. 6, the first surface includes the upper surface of the non-opaque substrate 611, and the second surface includes the lower surface of the non-opaque substrate 611.

As shown in FIG. 7, the device layer 612 includes a pixel area 6120. The pixel area 6120 includes a plurality of pixels (not shown), each of the plurality of pixels includes a non-opaque area (not shown) and a light-blocking area (not shown), the light-blocking area includes a photosensitive device (not shown), and the non-opaque area allows light to pass through the device layer 612 and the pixel area 6120.

Referring to FIG. 7, the point backlight source 620 is disposed below the pixel area 6120, and the angle between the light emitted from the point backlight source 620 and the first surface of the non-opaque substrate 611 is an acute angle. That is, the point backlight source 620 is also disposed outside of and under the pixel area 6120.

In the present embodiment, the point backlight source 620 includes a LED. In the present embodiment, the light emitted from the point backlight source 620 is shown as a black unidirectional arrow in FIG. 7. As shown in the cross section of FIG. 7, there is a first distance J1 between the point backlight source 620 and the area right below the pixel area 6120 in the horizontal direction; and in the vertical direction, there is a second distance J2 between the point backlight source 620 and the device layer 612. As described above, the point backlight source 620 is disposed below the pixel area 6120 due to the first distance J1 and the second distance J2, and it is easy to understand that the “below” means being disposed outside of and under the pixel area 6120. In the present embodiment, the point backlight source 620 may be disposed at an appropriate position by adjusting the value of the first distance J1 and the second distance J2 to improve the clarity of the fingerprint image formed by the optical fingerprint module.

As shown in FIG. 7, a non-opaque layer 630 may be disposed between the optical fingerprint sensor 610 and the point backlight source 620. The light emitted from point backlight source 620 can first enter the non-opaque layer 630, and then enter the optical fingerprint sensor 610. And, in the present embodiments, a refractive index of the non-opaque layer 630 is greater than 1.2, which further improves the performance of the optical fingerprint module. In the present embodiment, the non-opaque layer 630 may include a glass layer, a plastic layer, or an optical adhesive layer.

In the present embodiment, a side surface of the non-opaque layer 631 includes a light-focusing surface 631, and the light emitted from the point backlight source 620 entering the non-opaque layer 630 from the light-focusing surface 631, and the light-focusing surface 631 may be adapted to focus the light emitted from the backlight source 620 to parallel light or near-parallel light.

In the present embodiment, the light-focusing surface 631 of the non-opaque layer 630 may include an ellipsoid crown surface. In other embodiments, the light-focusing surface may include an inclined surface, a spherical crown surface, a conical side surface, or a pyramid side surface.

It should be noted that, in other embodiments, the light-focusing surface may be a lower surface of the non-opaque layer.

The entire optical fingerprint module provided in present embodiment can achieve fingerprint image recognition without a light guide plate to form a clear fingerprint image, which further simplifies the structure of the optical fingerprint module and lowers the cost. Further, the side surface of the non-opaque layer includes a light-focusing surface 631, and the light emitted from the point backlight source 620 enters the non-opaque layer 630 from the light-focusing surface 631, and the light-focusing surface 631 focuses the light emitted from the backlight source 620 to parallel light or near-parallel light. Therefore, when the fingerprint image acquisition is carried out, more light can be used for the fingerprint image capture, whereby the fingerprint image with higher definition and accuracy can be obtained, and optical fingerprint module with further improvement in the performance can be obtained.

Further, regarding the structure and properties of the optical fingerprint module provided in the present embodiment, reference can be made to the corresponding contents of the optical fingerprint module provided in the foregoing embodiments.

Another embodiment of present disclosure provides an optical fingerprint module, please refer to FIG. 8. FIG. 8 is a schematic cross-sectional view of an optical fingerprint module according to an embodiment of the present invention; the optical fingerprint module includes an optical fingerprint sensor 710 and a point backlight source 720.

As shown in FIG. 8, the optical fingerprint sensor includes one non-opaque substrate 711. A first surface (not labeled) of the non-opaque substrate 711 is used for fingerprinting contact. A second surface (not labeled) of the non-opaque substrate is covered with a device layer 712. As shown in FIG. 7, the first surface includes the upper surface of the non-opaque substrate 711, and the second surface includes the lower surface of the non-opaque substrate 711.

As shown in FIG. 8, the device layer 712 includes a pixel area 7120, the pixel area 7120 includes a plurality of pixels (not shown), each of the plurality of pixels includes a non-opaque area (not shown) and a light-blocking area (not shown), the light-blocking area includes a photosensitive device (not shown), and the non-opaque area allows the light to pass through the device layer 712 and the pixel area 7120.

Referring to FIG. 8, the point backlight source 720 is disposed below the pixel area 7120, and the angle between the light emitted from the point backlight source 720 and the first surface of the non-opaque substrate 711 is an acute angle. That is, the point backlight source 720 is also disposed outside of and under the pixel area 7120.

In the present embodiment, the point backlight source 720 includes a LED. In the present embodiment, the light emitted from the point backlight source 720 is shown as a black unidirectional arrow in FIG. 7. As shown in the cross section of FIG. 8, there is a first distance K1 between the point backlight source 720 and the area right below the pixel area 7120 in the horizontal direction; and in the vertical direction, there is a second distance K2 between the point backlight source 720 and the device layer 712. As described above, the point backlight source 720 is disposed below the pixel area 7120 due to the first distance K1 and the second distance K2, and it is easy to understand that “below” means being disposed outside of and under the pixel area 7120. In the present embodiment, the point backlight source 720 may be disposed at an appropriate position by adjusting the value of the first distance K1 and the second distance K2 to improve the clarity of the fingerprint image formed by the optical fingerprint module.

As shown in FIG. 8, in the present embodiment, a non-opaque layer 730 is disposed between the optical fingerprint sensor 710 and the point backlight source 720. The light emitted from point backlight source 720 first enters the non-opaque layer 730, and then enters the optical fingerprint sensor 710. Further, in the present embodiments, a refractive index of the non-opaque layer 730 is greater than 1.2, which further improves the performance of optical fingerprint module.

In the present embodiment, a side surface of the non-opaque layer 730 includes a light-focusing surface (not labeled), and the light emitted from the point backlight source 720 enters the non-opaque layer 730 from the light-focusing surface, and the light-focusing surface focuses the light emitted from the backlight source 720 to parallel light or near-parallel light.

Further, a second anti-reflective layer 740 is disposed on the light-focusing surface of the non-opaque layer 730, and the second anti-reflective layer 740 can increase the proportion of the light emitted from the backlight source 720 entering into non-opaque layer 730.

Further, in the optical fingerprint module provided by the present embodiment, the side surface of the non-opaque layer 730 can be made into a light-focusing surface, and the light-focusing surface can focus the light of the backlight source 720 into parallel light or near-parallel light. The light emitted from the point backlight source 720 first enters the non-opaque layer 730 from the light-focusing surface, and then enters the optical fingerprint sensor 710. Therefore, parallel light or near-parallel light can be used for fingerprint image acquisition to obtain fingerprint images with smaller distortion and higher accuracy, which further improves the performance of optical fingerprint image sensor module.

Further, a second anti-reflective layer 740 is disposed on the side surface of the non-opaque layer 730. The second anti-reflective layer can increase the proportion of the light emitted from the backlight source 720 entering into the non-opaque substrate. Therefore, when the fingerprint image acquisition is carried out, more light can be used for the fingerprint image capture, whereby the fingerprint image with higher definition and accuracy can be obtained, and optical fingerprint module with further improvement in the performance can be obtained.

Although the present invention is disclosed as above, the present invention is not limited thereto. It should be understood by those skilled in the art that various changes and modifications can be made therein without departing from the spirit and scope of the invention, and that the scope of the invention is defined by the scope of the claims.

1. An optical fingerprint module, comprising:
an optical fingerprint sensor; and
a point backlight source; wherein:
the optical fingerprint sensor comprises one non-opaque substrate;
a first surface of the non-opaque substrate is used for fingerprinting contact;
a second surface of the non-opaque substrate is covered with a device layer;
the device layer comprises a pixel area, the pixel area comprises a plurality of pixels; each of the plurality of pixels comprises a non-opaque area and a light-blocking area, and the light-blocking area comprises a photosensitive device formed therein; the non-opaque area allows light to pass through the pixel area of the device layer; and
the point backlight source is disposed below the pixel area, and an angle between the light emitted from the point backlight source and the first surface of the non-opaque substrate is an acute angle.

2. The optical fingerprint module according to claim 1, wherein the point backlight source is disposed below the device layer, and the light emitted from the point backlight source penetrates through the non-opaque area to the device layer, and then enters into the non-opaque substrate.

3. The optical fingerprint module according to claim 1, wherein each of the plurality of pixels further comprises a light shielding layer, the photosensitive device is disposed between the light shielding layer and the non-opaque substrate, the light shielding layer is disposed between the photosensitive device and the point backlight source.

4. The optical fingerprint module according to claim 1, wherein the point backlight source comprises at least one LED, and the light of the LED comprises near ultraviolet light, violet light, blue light, green Light, yellow light, red light, near infrared light or white light; or the backlight source comprises two or more LEDs, the two or more LEDs symmetrically disposed below the optical fingerprint sensor, and the light of the LED comprises near ultraviolet light, purple light, blue light, green light, yellow light, red light, near infrared light or white light.

5. The optical fingerprint module according to claim 1, wherein the point backlight source comprises a focusing lens in front of a light emitting surface of the point backlight source; the focusing lens is adapted to focus the light emitted from the point backlight source to parallel light or near parallel light, and the light emitted from the point backlight source first enters the focusing lens, and then enters the optical fingerprint sensor.

6. The optical fingerprint module according to claim 1, wherein a first anti-reflective layer is disposed on the surface of the device layer, and the first anti-reflective layer is adapted to increase the proportion of the light emitted from the point backlight source entering into the optical fingerprint sensor.

7. The optical fingerprint module according to claim 1, wherein a non-opaque layer is disposed between the optical fingerprint sensor and the backlight source, and the light emitted from the point backlight source first enters the non-opaque layer, and then into the optical fingerprint sensor.

8. The optical fingerprint module according to claim 7, wherein a side surface or a lower surface of the non-opaque layer act as a light-focusing surface, and the light emitted from the point backlight source enters from the light-focusing surface to the non-opaque layer, where the light-focusing surface focuses light emitted from the point backlight source into parallel light or near-parallel light.

9. The optical fingerprint module according to claim 7, wherein a second anti-reflective layer is disposed on a side surface or a lower surface of the non-opaque layer, and the second anti-reflective layer is adapted to increase the proportion of the light emitted from the point backlight source entering into the non-opaque layer.

10. The optical fingerprint module according to claim 8, wherein the non-opaque layer comprises a glass layer, a plastic layer, or an optical adhesive layer; and the light-focusing surface of the non-opaque layer comprises a slant surface, a spherical crown surface, an ellipsoidal crown surface, a conical side surface or a pyramid side surface.

11. The optical fingerprint module according to claim 7, wherein a refractive index of the non-opaque layer comprises is greater than 1.2.

12. The optical fingerprint module according to claim 1, wherein a filter layer is disposed on at least one of the first surface and the second surface of the non-opaque substrate.

13. The optical fingerprint module according to claim 2, wherein each of the plurality of pixels further comprises a light shielding layer, the photosensitive device is disposed between the light shielding layer and the non-opaque substrate, the light shielding layer is disposed between the photosensitive device and the point backlight source.

14. The optical fingerprint module according to claim 2, wherein the point backlight source comprises at least one LED, and the light of the LED comprises near ultraviolet light, violet light, blue light, green Light, yellow light, red light, near infrared light or white light.

15. The optical fingerprint module according to claim 8, wherein a second anti-reflective layer is disposed on a side surface or a lower surface of the non-opaque layer, and the second anti-reflective layer is adapted to increase the proportion of the light emitted from the point backlight source entering into the non-opaque layer.

16. The optical fingerprint module according to claim 8, wherein a refractive index of the non-opaque layer comprises is greater than 1.2.

17. The optical fingerprint module according to claim 10, wherein a refractive index of the non-opaque layer comprises is greater than 1.2.

18. The optical fingerprint module according to claim 14 wherein the point backlight source comprises two or more LEDs, the two or more LEDs symmetrically disposed below the optical fingerprint sensor, and the light of the LED comprises near ultraviolet light, purple light, blue light, green light, yellow light, red light, near infrared light or white light.
